(19) United States
(12) Patent Application Publication
(10) Pub. No.: US 2026/0210427 A1
(43) Pub. Date: Jul. 23, 2026

(54) BELT TENSIONING APPARATUS FOR BELT DRIVEN SYSTEMS

(71) Applicant: SPRINGLAND MANUFACTURING, Rivers (CA)

(72) Inventors: HENRY LEPP, Rivers (CA); ROY ALVARENGA, Rivers (CA)

(21) Appl. No.: 19/032,619

(22) Filed: Jan. 21, 2025

(51) Int. Cl. F16H 7/14; B65G 23/02; F16H 7/08

(52) U.S. Cl. CPC F16H 7/14; B65G 23/02; F16H 2007/0865; F16H 2007/0891; F16H 2007/0895

(57) ABSTRACT

An adjustable tensioning assembly suitable for use with bulk granular product transport devices. The assembly utilizes a movable drive for a driven pulley wheel in a belt drive having an idler pulley wheel surrounded by the belt. A mechanical cam releasable lock which is adjustably biassed with a biasing arrangement assists movement of the driven pulley into and out of engagement with the belt. Proper tension in the belt is adjustable with at least the biasing arrangement to prevent improper operation and premature wear of the belt drive and related components. An indicator arrangement is provided to alert a user to proper tension of the belt.

### FIELD OF THE INVENTION

The present invention relates to a belt tensioning device and more particularly, the present invention relates to a tensioning device for belt driven systems.

### BACKGROUND OF THE INVENTION

Generally speaking, improper belt tensioning tension can lead to premature wear of the belt itself, undue stress on the drive motor, bearing stress, jamming or even disengagement of the belt from the pulleys entirely.

For bulk granular product transport of grains, seeds, etc. Belt driven systems are widely employed. Equipment dependability and speed are directly related to profitability for suppliers of grains etc. Deployment of, for example, grain augers must be expeditious and absent mechanical failure. As such, the belt driven arrangements must not only provide the maximum longevity, but also must be simple to repair when required.

Madeira, in U.S. Pat. No. 2,725,976 , issued Dec. 6, 1955, provides a tensioning arrangement for belt conveyors. The arrangement has a driving roller and a movable tension idler roller for varying tension on the belt. A carriage supports the tension idler roller for movement release and alleviate tension. The motor has a winch connected to the carriage for moving it to reduce tension on the belt.

Radocaj, in U.S. Pat. No. 4,402,677 , issued Sep. 6, 1983, discloses a belt tensioner construction for tensioning an endless drive belt of the drive system for vehicle accessories. The arrangement utilizes a first cam and a second cam engageable with the first cam. A spring biasses the second cam into engagement with the first cam. A shaft is mounted on the first cam an idler pulley on the shaft and engages and tensions the drive belt.

In U.S. Pat. No. 11,009,106 , issued May 18, 2021, Vegh et al. teach:
“In material handling systems, if the belt tension of the drive belt (e.g., timing belt), such as toothed belts, is less than an optimum value, the torque transmission capability of the drive bell may be degraded. On the other hand, for cases in which the belt tension of the drive belt exceeds the optimum value, the component life of the drive and driven components may be degraded. To maximize torque transmission capability and experience an extended service life, the belt tension should remain at an optimum value or at substantially an optimum value during operation.
   The system and method of tensioning drive belts described herein, in accordance with one or more example embodiments, relies on a fixed center of rotation that is defined by a driving mechanism, upon which when a torque is applied, a drive assembly rotates around the fixed center of rotation to create or reduce tension on a drive belt.”

Kataria et al. in United States Patent Publication No. US 2021/0101753, published Apr. 8, 2021, teach a belt drive condition monitoring system. The system utilizes transducers for transmitting and receiving acoustic signals from the surface of tension side of a belt drive, the slack side of belt drive, the surface of the driver pulley inter alia. Apparatus is provided to generate, transmit, receive, amplify, process and analyze electrical signals and corresponding acoustic signals to accumulate information about tension of the belt or slip of the belt with respect to the pulleys or both tension and slip.

The meritorious arrangements in the prior art do not address a simplified tensioning arrangement for conveying systems employing the mechanical efficiency of a cam and contoured seating therefor with minimal moving parts and an indicator to always inform a user of the proper tension in the belt system.

The present invention in its embodiments is directed to providing such an arrangement and a method of utilizing same.

### SUMMARY OF THE INVENTION

One object of the present invention is to provide a tensioning arrangement for use in a belt driven system conveying apparatus.

Another object of one embodiment of the present invention is to provide a belt tensioning apparatus for a belt driven system having an idler pulley and a driven pulley, comprising:
a support structure;
a drive member having a drive pulley wheel, said drive member movably mounted on the support structure;
an adjustable tension assembly connected to the support structure and the drive member for adjusting belt tension responsive to movement of the drive member; and
an over center locking assembly operatively connected to the adjustable tension assembly and the drive member for releasably locking the drive member into an engagement position where the drive pulley is engaged with the belt.

The apparatus in some embodiments may include an indicator member connected to the adjustable tension assembly for indicating optimal belt tension during use.

In one embodiment, the adjustable tension assembly can include a movable cam and seating therefor with the movable cam being releasably engageable in the seating for releasable locking in said seating.

The movable cam may include a plurality of individual cam members or a single unit.

The seating for the cam is contoured to the shape of the cam surface and may include a coating to reduce friction.

In some embodiments, the seating may include an adjustable biasing member for assisting engagement and disengagement of the locking assembly when the moveable cam is actuated. Any suitable biasing arrangement may be used, such as a spring or a hydraulic, pneumatic or electrical arrangement capable of providing a degree of resiliency.

Conveniently, the apparatus provides an indicator arrangement for indicating the tension of the belt. In some embodiments, this may comprise a pointer and indicia or may comprise an audible indication alerting a user to ideal tension. Combinations of these are envisioned.

The apparatus may be utilized in any arrangement requiring a belt drive an example of which is a conveying system for conveying materials. For the latter, this may comprise a bulk granular product conveyor such as a field loader, an open trough grain auger, tube auger, etc.

Another object of one embodiment of the present invention is to provide a belt tensioning apparatus for a belt driven system having an idler pulley and a driven pulley operable with a belt, comprising:
a support structure;
a drive member having a drive pulley wheel, the drive member movably mounted on the support structure;
an over center tensioning assembly connected between the support structure and the drive member movable to releasably lock the drive pulley wheel into engagement with the belt from movement of the drive member; and
an adjustable biasing member operatively connected to the over center tensioning assembly for adjusting belt tension.

A further object of one embodiment of the present invention is to provide a tensioning apparatus for a bulk granular product conveyor, comprising:
a pulley driven belt with an idler pulley and a driveable pulley to mobilize said belt;
a movable drive member for said driven pulley mounted for movement on a frame of said conveyor;
a releasably lockable cam member between said movable drive member and a fixed point on said frame for releasably locking said drive member into an engagement position where said driven pulley is engaged with said belt; and
a biasing member operatively coupled with said lockable cam member to bias said cam into a lock position and maintain a predetermined tension for said belt.

A still further object of one embodiment of the present invention is to provide a method for tensioning a belt on a belt driven apparatus for conveying bulk granular products, comprising:
providing a movable drive member having a drivable pulley, said drivable pulley being movable into and out of engagement with a belt positioned about said drivable pulley and an idler pulley when said movable drive member is moved;
coupling a releasably lockable cam member between said movable drive member and a fixed point on said apparatus;
biasing said lockable cam member to selectively lock said movable drive member into a position where said drivable pulley tensions said belt; and
selectively adjusting the bias of said lockable cam member for proper tensioning of said belt during use or for disengagement.

Having thus generally described the invention, reference will now be made to the accompanying drawings, illustrating preferred embodiments.

### BRIEF DESCRIPTION OF THE DRAWINGS

FIG. 1 is a perspective view of one embodiment of a bulk granular product conveyor;

FIG. 2 is a schematic view of the relational movement of the pulley wheels and drive member of the adjustable tensioning system;

FIG. 3 is a schematic view of the relation of the components of the adjustable tensioning system;

FIG. 4 is an enlarged view of the locking and biasing arrangements;

FIGS. 5A and 5B are schematic illustrations illustrating the movement of the cam arrangement;

FIG. 6 is an enlarged view of a portion of the cam and supporting shaft;

FIG. 7 is an exploded view of the adjustable tensioning arrangement components;

FIG. 8 is a schematic view of an alternate embodiment;

FIG. 9 is an exploded view of the guard assembly;

FIG. 10 is a schematic view of an alternate embodiment;

FIG. 11 is a schematic view of a conventional conveyor structure for conveying materials; and FIG. 12 is a schematic view of the applicability of the technology to other areas for implementation.

Similar numerals employed in the Figures denote similar elements.

### DESCRIPTION OF THE PREFERRED EMBODIMENTS

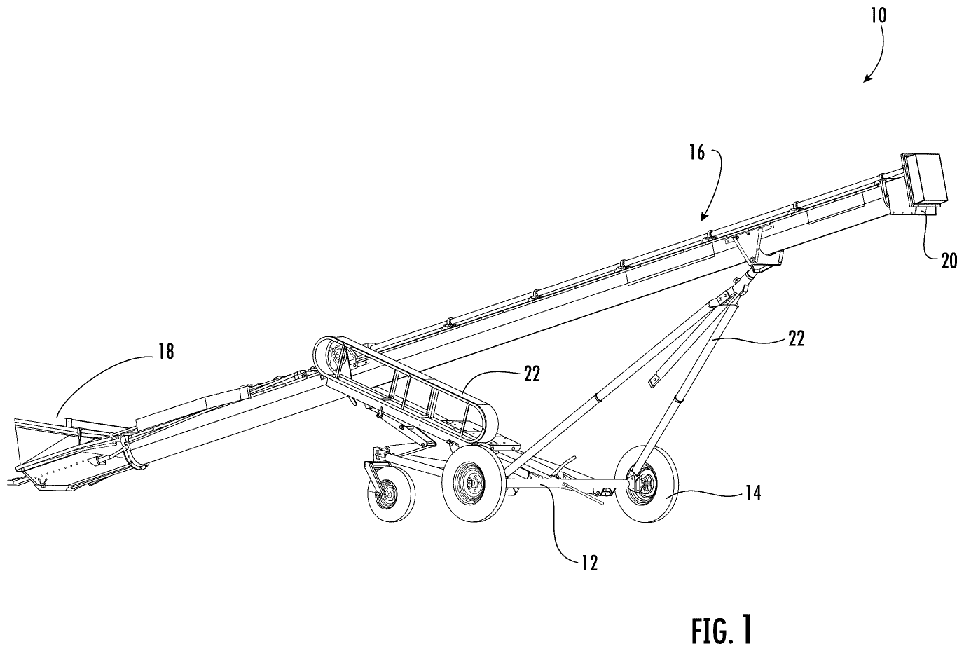

Referring now to FIG. 1, shown is an example of a conveying device 10 for conveying bulk granular products, such as seed, grains, etc. The example depicts a trough loader. As is known, such devices include a frame or supporting structure which is wheeled for mobilizing the apparatus 10. A conveyance area 16, shown in the example as a trough has a loading area 18 and a discharge area 20 distal therefrom. The conveyance area 16 is supported by a supporting structure 22.

Device 10 is driven by a continuous belt (not shown in this Figure) at least partially housed with a belt guard 22. Device 10 typically includes a drive member, such as an engine for driving the belt arrangement which will be elucidated further in respect of the description of the advancing Figures.

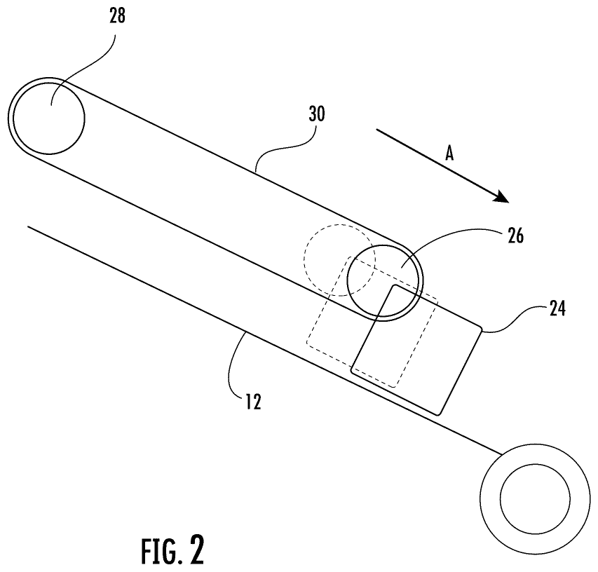

Turning now to FIG. 2, a schematic illustration is provided with parts removed for clarity. In this Figure, the support frame 12 is provided with drive member 24. This can be any suitable arrangement such as an electric motor, gas or diesel engine or connection site for a PTO. Drive member 24 includes a driveable pulley wheel 26. Pulley 26 communicates with an idler pulley 28, which is utilized to transmit motion to cooperating conveying members (not shown) associated with the conveyance area 16 referenced in FIG. 1.

A continuous belt 30 is disposed about pulleys 26 and 28 and selectively engageable in a tensioned manner therewith to facilitate the motion from drivable pulley wheel 26 to be imparted to idler pulley 28.

In FIG. 2, the dashed lines for pulley 26 and drive member 24 depict the position of these members relative to the belt 30 in the non-operating position.

The solid line depiction of these elements indicates an operating position where the belt is engaged by both pulleys 26 and 28. This is achieved by movement of drive member 24 in the direction indicated as “A”.

Drive member 24 is movably mounted on frame 12 and this movement is operative with an adjustable tension assembly and locking assembly which will now be discussed.

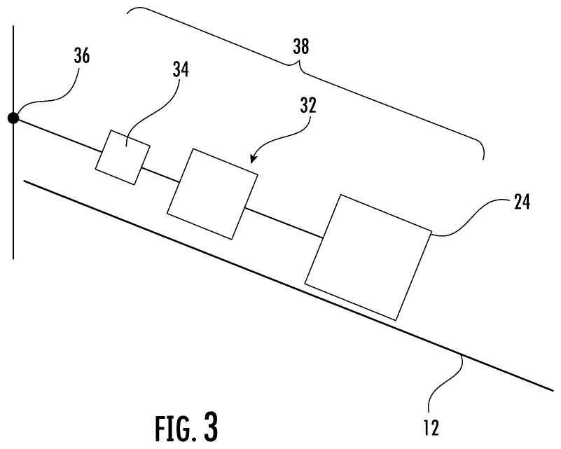

FIG. 3 is a schematic block diagram generically depicting the disposition of the adjustable tension assembly, locking assembly drive member 24 and frame 12. The locking assembly, globally referenced as 32, is operatively connected to the drive member 24 and to a tensioner 34. Tensioner 34 is connected at a fixed point 36 on frame 12. Numeral 38 globally references the adjustable tension assembly.

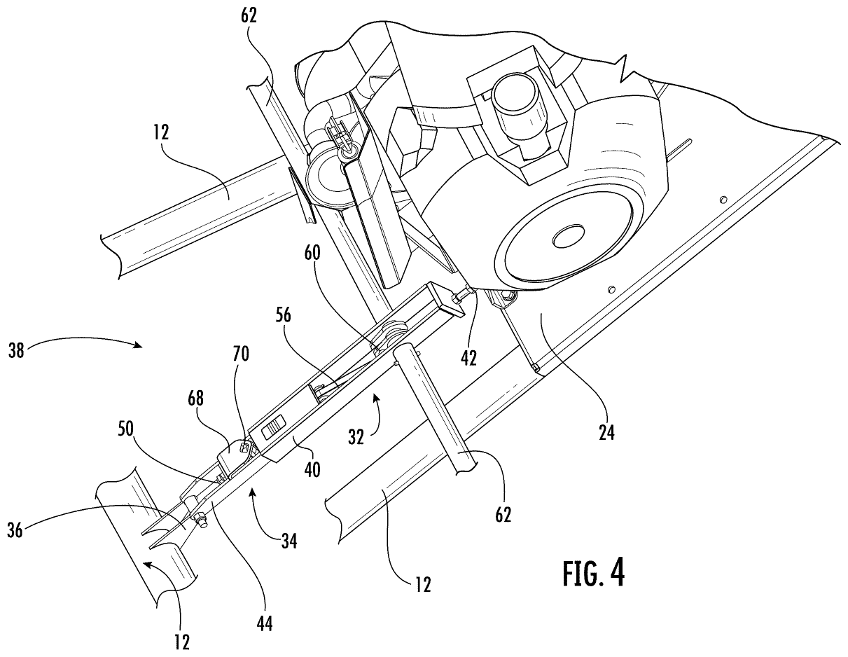

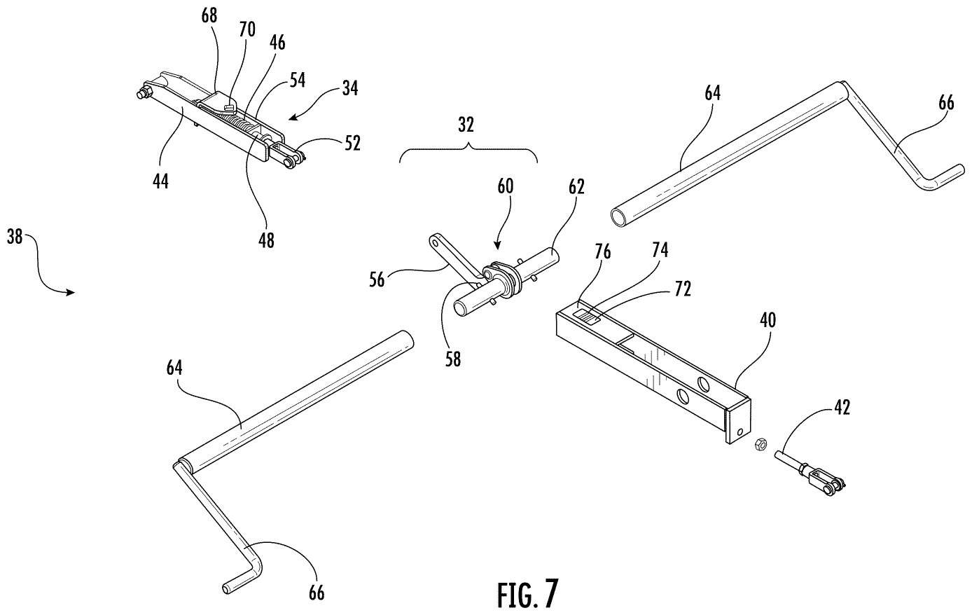

FIG. 4 is an enlarged section illustration of adjustable tension assembly 38. Reference to FIG. 7 may also be had for clarification. Drive member 24 is connected to a yoke 40 with an adjustable fastener 42, shown in the example as an adjustable clevis. Yoke 40 is slidably mounted in coaxial relation with a yoke 44. Yoke 44 includes a biasing member 46 disposed about shaft 48. Shaft 48 has at one end an adjustable fastener 50 and a clevis 52 at an opposed end.

A stop 54 is provided adjacent clevis 52 and is located about shaft 48.

Stop 54 is utilized to adjust the compression/extension of biasing member 46 through adjustment of adjustable fastener 50.

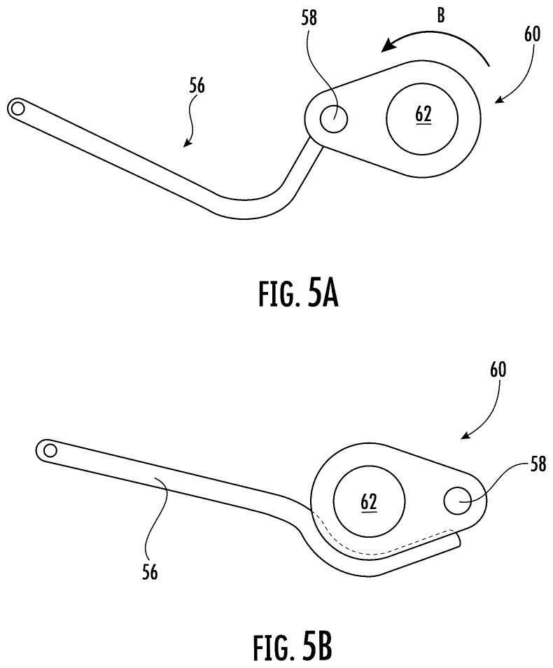

Clevis 52 links connection to a moveable locking seating linkage 56. Linkage 56 is contoured and movably connected at 58 to a cam member 60 also shown in FIGS. 5A and 5B. The contour of linkage 56 is configured to receive cam 60, such that cam 60 can be securely and lockably seated within the contour.

Cam member 60 is journalled on an actuator shaft 62 which fixedly secures the cam member thereto. The actuator 62 extends through yoke 40 and is at least partially supported by resting contact on frame members 12. Rotation of actuator 62 allows for the rotation of the cam member 60 within yoke 40.

FIGS. 5A and 5B schematically illustrate the result of actuation where the cam member 60 is securely seated within the contour of linkage 56 from the initial position shown in FIG. 5A to the secured position of FIG. 5B. As is illustrated the mechanical relationship of the cam 60 and linkage 56 is an over center locking cam arrangement. The cam 60, in this example is generally egg shaped, however other suitable geometries will be appreciated by those skilled. The cam system is useful to provide a mechanical advantage, however non cammed arrangements may be employed utilizing the over center principle of operation. This will be discussed in the advancing Figures.

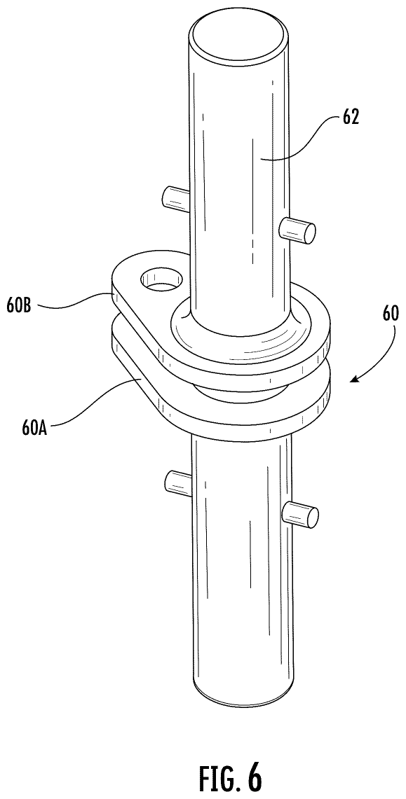

FIG. 6 is an enlarged view of the cam member 60 as fixed on the actuator shaft 62. In the embodiment shown, the cam member 60 utilizes two identical cams 60A and 60B in spaced relation. Fixture to shaft 62 may be by, for example, welding. In the example where the cam has 60A and 60B, at least a portion of the contour of linkage 56 is received within the spacing of the cams 60A and 60B. reference may be had to FIG. 5 B where dashed lines illustrate this. This has an advantage of imparting additional strength to the connection and mitigates and torque or transverse forces that may evolve.

FIG. 7 is an exploded view of the overall adjustable tension assembly 38 with some parts removed for clarity. Actuator shaft 62 may include extensions 64 each terminating in a handle 66 to allow a user to effect rotational movement of the cam member 60, which, in turn, effects movement of the drive member 24 and thus the driveable pulley 26, the latter elements being shown in FIG. 2.

To ensure proper tension of the belt 30 between the pulleys 26 and 28, an indicator arrangement may be utilized. In FIG. 7, yokes 40 and 44 owing to the coaxial and moveable relation cooperate to provide tension indication. Yoke 44 includes tension locator 68 connected to the biasing member 46. Locator 68 has an opening 70 therethrough. Yoke 40 includes indicia 72, 74, 76 thereon which are visible through opening 70 when the yokes 40 and 44 are coaxially engaged. Indicia 72 and 76 are representative of improper tension, whereas indicia 74 indicates optimal tension in the belt (not shown).

As will be appreciated by those skilled in the art, over repeated use, belts on belt driven devices can stretch from heat, lose mass and thus dimension from wear, become loose on the pulleys from pulley expansion and contraction or stretch the belt from mechanical jamming of the conveyance members (not shown). Advantageously, such irregularities can be mitigated by the adjustment of the biasing member 46 since the performance anomalies are translatable mechanically to the biasing member 46. This allows a user to visually identify tension variation and correct it during use of the apparatus or during a period of non-use.

In respect of alternatives, it will be appreciated that existing conveyance apparatus may be retrofit with the technology arrangement discussed herein.

Accordingly, auger, screw, belt, etc., type conveyance devices can incorporate the adjustable tension assembly.

The indicator arrangement may be visual as discussed in connection with FIG. 7 or audible. In this regard, sensors 78 may be utilized on yoke 40 for communication with a transceiver/receiver 80 to alert a user visually, audibly or a combination thereof as to correct tension with signal 82.

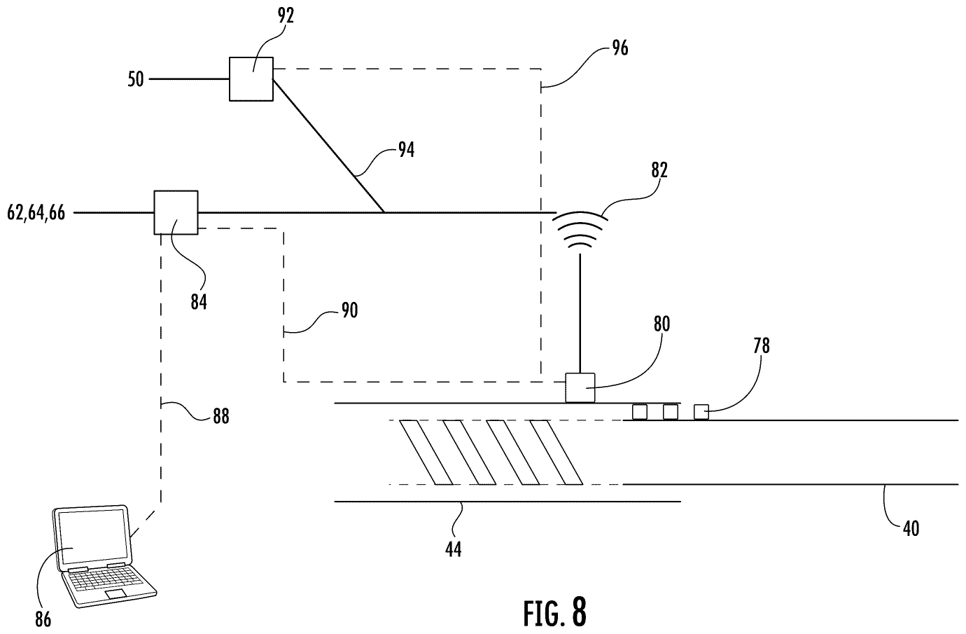

In further embodiments, signal 82 may be sent to a motor 84 capable of receiving signal 82 with the motor operatively connected to any one of 62,64,66, to automatically as illustrated in FIG. 8. Utilizing a portable electronic device 86 such as a laptop, cell phone, app, etc., a user could adjust the tension through communication remotely by signalling at 88 to the motor 84. Further, a signal feedback loop 90 could be incorporated to enhance automation dynamically.

In a similar manner, adjustable fastener 50 may be motor driven with motor 92 and operate to respond to signalling at 94 or in a feedback loop at 96.

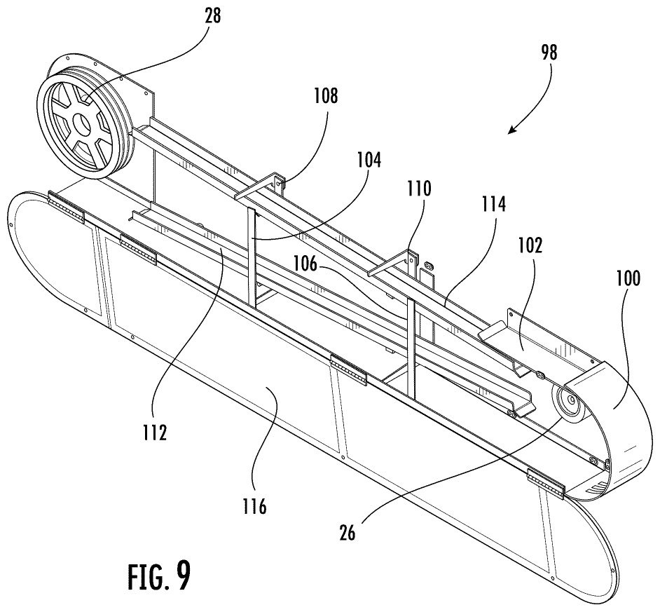

Turning to FIG. 9, shown is an exploded view of a belt guard assembly 98, generally depicted initially in FIG. 1 as belt guard 22. The assembly 98 will now be further elucidated.

Assembly 98 provides a belt shield 100 positioned about drive pulley wheel 26 extending to idler pulley wheel 28. A belt holding member 102 is connected to shield 100 and functions to retain the belt (not shown) loosely about pulley 26 when it is not tensioned for use.

Support members 104 and 106 are fixed within the shield 100 in spaced relation and each include guide arms 108 and 110. Supports 104 and 106 support belt trays 112 and 114 spaced inwardly from the belt shield 100. Each of the trays 112 and 114 has a general U shaped configuration and diverge from a point adjacent pulley 26 to pulley 28 as illustrated.

The U shaped configuration assists in retaining the belt (not shown) therein when the belt is not tensioned. This is further assisted by making use of the belt holding member 102 which overlies in spaced relation the terminal end of tray 114. Further, guide arms 108 and 110 being disposed above the tray 114 contribute to location and retention of the belt. It will be understood that these elements assist in location and retention of the belt when tensioned or when relaxed in a loose position. A guard door 116 may be utilized to shroud the entire assembly.

Guard assembly 98 presents significant advantages to the overall structure and functioning. Since the belt is guided and located as discussed, adjustment of the tension of the belt can be conducted during operation of the device without concern for belt disengagement, excessive transverse excursion or issues when the drive pulley wheel 26 is disengaged. This advantageously eliminates the need for a clutch assembly.

It will be appreciated by those skilled that this is a significant feature. Generally clutch assemblies in mechanical devices experience a significant amount of wear and are a key failure point. Clutches are typically expensive, costly to repair and exacerbate downtime in productivity.

It has been found that the guard assembly obviates the need for a clutch assembly entirely.

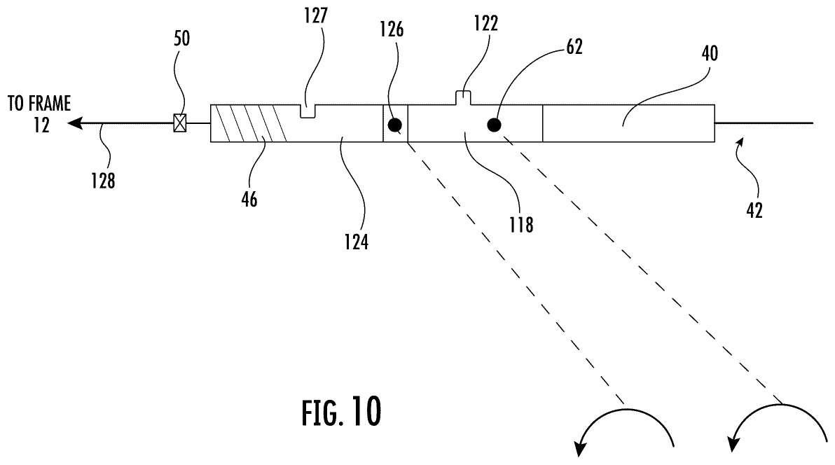

FIG. 10 is a schematic illustration of a further alternate embodiment. In this embodiment, the arrangement substitutes levers or linkages for the cam arrangement discussed in respect of FIG. 4. The yokes are removed for clarity.

In FIG. 10, a lever or linkage arm 118 is fixedly journalled on actuator shaft 62 and includes a projection 122 extending from the surface thereof. Linkage arm 118 is rotatably connected to a second linkage arm 124 at 126 and is fixed at the opposed end 128 to frame 12.

Linkage arm 124 includes a recess 127 therein to releasably receive projection 122 when the actuator shaft 62 is rotated. This over center locking assembly operates by a similar principle to that discussed in respect of FIG. 4 and delineates an alternative to the cam type arrangement previously specified. The projection 122 and recess 127 can be reversed in other embodiments and include plural projections and recesses as alternatives.

In terms of other alternatives, it will be appreciated that adjustment members and arrangements as well as the biasing arrangement may include shape memory alloys.

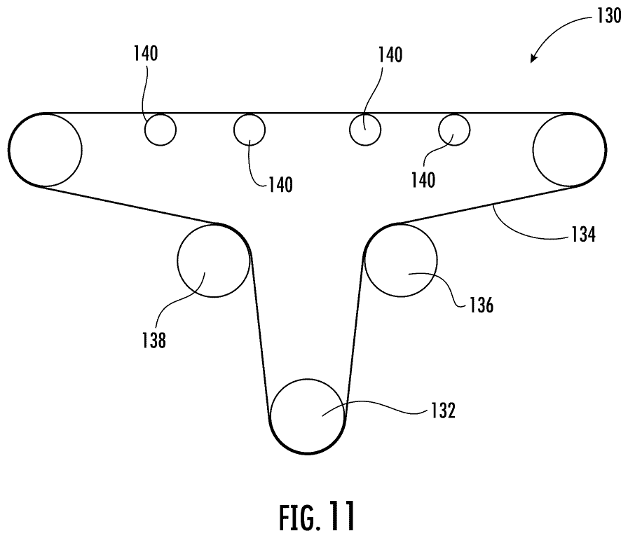

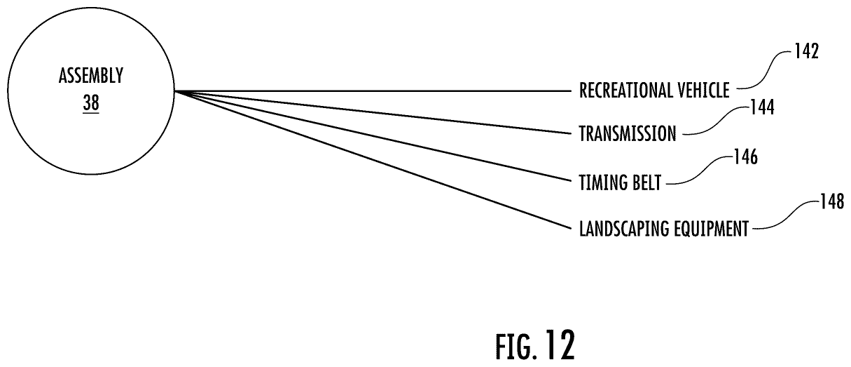

FIG. 11 is a schematic view of a generic conveyor belt arrangement 130. In such arrangements, use is made of a take up pulley or roller 132 to mitigate slack in the belt 134. This is augmented by tensioner pulleys or rollers 136 and 138. It will be evident to those skilled that the greater the quantity of pulleys incorporated in a given system, the greater the rate of belt wear from additional contact with an increased demand on the driving member, such a motor (not shown).

Utilization of the assembly 38 circumvents these issues. With the proper tensioning in the system afforded by the embodiments herein, the quantity of driven pulleys or rollers can be reduced in a simplified arrangement.

In the example of FIG. 11, supporting idler rollers 140 are often used. With the tensioning arrangement discussed herein, proper tensioning can significantly reduce the number of rollers 140 required. Proper tensioning has the added benefit of augmenting the load capability of the belt 134.

The over center arrangements disclosed herein can be incorporated in any belt driven system. FIG. 12 illustrates additional areas of applicability of the assembly 38 to drive components in recreational vehicles 142 examples of which include snowmobiles, jet skis, track driven vehicles, belt driven transmission 144 arrangements, timing belt arrangements 146 and landscaping equipment 148, such as lawnmowers. Other areas of applicability will be appreciated by those skilled.

1.-13. (canceled)

14. A belt tensioning apparatus for a belt driven system having an idler pulley and a driven pulley operable with a belt, comprising:
a support structure;
a drive member having a drive pulley wheel, said drive member movably mounted on said support structure;
an over center tensioning assembly connected between said support structure and said drive member movable to releasably lock said drive pulley wheel into engagement with said belt from movement of said drive member; and
an adjustable biasing member operatively connected to said over center tensioning assembly for adjusting belt tension.

15. The apparatus as set forth in claim 14, further including a belt guard member at least partially enclosing said drive member, said over center tensioning assembly and said adjustable biasing member.

16. The apparatus as set forth in claim 15, wherein said belt guard member includes a belt holder.

17. The apparatus as set forth in claim 15, wherein said belt guard member includes spaced apart belt trays for guiding and locating said belt.

18.-22. (canceled)

23. A method for tensioning a belt on a belt driven apparatus for conveying bulk granular products, comprising:
providing a movable drive member having a drivable pulley, said drivable pulley being movable into and out of engagement with a belt positioned about said drivable pulley and an idler pulley when said movable drive member is moved;
coupling a releasably lockable cam member between said movable drive member and a fixed point on said apparatus;
biasing said lockable cam member to selectively lock said movable drive member into a position where said drivable pulley tensions said belt; and
selectively adjusting the bias of said lockable cam member for proper tensioning of said belt during use or for disengagement.

24. The method as set forth in claim 23, further including providing said apparatus with at least one of audible, visual and combinations thereof indicative of optimal belt tension.

25. The method as set forth in claim 24, further including automatically adjusting the bias of a locked cam member in use.

26. A belt tensioning apparatus for a belt-driven system having a belt extending about an idler pulley and a driven pulley, comprising:
a support structure;
a drive member carrying said driven pulley, said drive member being mounted to said support structure for guided movement along a defined path relative thereto to vary tension in said belt;
a locking assembly operatively coupled between said drive member and a fixed portion of said support structure, said locking assembly including:
a cam member mounted for rotation about an axis, and
a seating structure having a defined engagement surface;
a biasing member operatively coupled with said cam member;
wherein:
said cam member is movable into a seated position in which a portion of said cam member is received against said engagement surface of said seating structure;
said seated position defines a discrete mechanical engagement state corresponding to a predetermined belt tension, said predetermined belt tension being established by the geometry of interaction between said cam member and said seating structure;
said biasing member urges said cam member toward said seated position and maintains said cam member in said discrete mechanical engagement state during operation; and
said biasing member further provides a restoring force that assists displacement of said cam member out of said seated position upon actuation, thereby permitting movement of said drive member to reduce belt tension.

27. The apparatus of claim 26, wherein said engagement surface comprises a recess configured to receive a portion of said cam member.

28. The apparatus of claim 26, wherein said cam member comprises an eccentric cam profile.

29. The apparatus of claim 26, wherein said biasing member comprises a spring acting between said cam member and said support structure.

30. The apparatus of claim 26, wherein said cam member is mounted on an actuator shaft.

31. The apparatus of claim 30, wherein said actuator shaft is supported in a yoke coupled to said drive member.

32. The apparatus of claim 31, wherein said biasing member is coupled to said yoke for coordinated movement therewith.

33. The apparatus of claim 26, further including an indicator member mechanically linked to said cam member or said biasing member, said indicator member providing a signal indicative of said seated position.

34. The apparatus of claim 33, wherein said indicator member provides at least one of a visual or audible indication when said cam member is in said seated position.

32. The apparatus of claim 26, wherein said guided movement of said drive member is linear along a predefined axis.

33. The apparatus of claim 26, wherein said seated position resists displacement of said drive member under load without continuous adjustment.

34. A tensioning apparatus for a bulk granular product conveyor, comprising:
a pulley driven belt extending about an idler pulley and a driven pulley;
a movable drive member supporting said driven pulley and mounted for guided movement relative to a frame of said conveyor;
a locking mechanism disposed between said movable drive member and a fixed portion of said frame, said locking mechanism including:
a cam member movable about an axis, and
a seating structure having a defined engagement surface configured to receive a portion of said cam member;
a biasing member operatively coupled with said cam member;
wherein:
said cam member is movable into a seated position in which said cam member engages said engagement surface of said seating structure;
said seated position defines a discrete mechanical engagement state corresponding to a predetermined belt tension, said predetermined belt tension being established by relative geometry between said cam member and said seating structure;
said biasing member urges said cam member into said seated position and maintains said cam member in said discrete mechanical engagement state during operation; and
said biasing member further assists movement of said cam member out of said seated position upon actuation to permit release of belt tension.

35. The apparatus of claim 34, wherein said cam member is configured to be seated in a defined engagement position.

36. The apparatus of claim 34, wherein said seating structure includes a plurality of engagement regions, each configured to receive said cam member in a respective seated position.

37. The apparatus of claim 34, wherein said seated position resists displacement of said movable drive member under operational belt loading without continuous adjustment of said biasing member.

38. The apparatus of claim 34, wherein said cam member and said seating structure are configured such that belt load increases retention of said cam member in said seated position.

39. The apparatus of claim 34, wherein said cam member is configured to facilitate release after initial displacement.

40. The apparatus of claim 34, wherein said biasing member is configured to assist displacement of said cam member after initial release from said seated position.

41. The apparatus of claim 34, wherein said predetermined belt tension is defined by geometric interaction between said cam member and said seating structure independent of incremental positional adjustment of said movable drive member.

42. The apparatus of claim 34, wherein said seated position establishes a repeatable tension condition upon repeated engagement of said cam member with said seating structure.

43. The apparatus of claim 34, further comprising an indicator member operatively coupled to said cam member or said biasing member, said indicator member being configured to provide an indication only when said cam member is in said seated position.

44. The apparatus of claim 43, wherein said indicator member is configured to change state upon displacement of said cam member from said seated position.

45. The apparatus of claim 34, wherein said cam member is configured to permit controlled, progressive release of belt tension upon displacement from said seated position.
